(19) United States
(12) Patent Application Publication
(10) Pub. No.: US 2008/0098224 A1
(43) Pub. Date: Apr. 24, 2008

(54) PROCESSES AND APPARATUS FOR ESTABLISHING A SECURED CONNECTION WITH A JOINT TEST ACTION GROUP PORT

(75) Inventors: Miao Hui, Ji'nan (CN); Lv Ling, Shanghai (CN)

Correspondence Address: PERKINS COIE LLP;PATENT-SEA, P.O. BOX 1247, SEATTLE, WA, 98111-1247, US

(73) Assignee: Spreadtrum Communications Corporation, Sunnyvale, CA (US)

(21) Appl. No.: 11/923,477

(22) Filed: Oct. 24, 2007

(30) Foreign Application Priority Data
Oct. 24, 2006 (CN) 200610117452.3

(51) Int. Cl. H04L 9/32

(52) U.S. Cl. 713/170

(57) ABSTRACT

Processes and apparatus for establishing a secure joint test action group port on a chip are disclosed herein.

### CROSS-REFERENCE TO RELATED APPLICATION

This application claims priority to Chinese Patent Application No. 200610117452.3, filed Oct. 24, 2006, the disclosure of which is incorporated herein by reference in its entirety.

### TECHNICAL FIELD

The present disclosure is related to methods and apparatus for establishing security control of Joint Test Action Group (JTAG) ports on a semiconductor chip. In particular, the present disclosure is related to authentication processes and system for authenticating a secure JTAG connection.

### BACKGROUND

Joint Test Action Group (JTAG) ports are used for testing the logic functions of internal ports in a semiconductor chip after encapsulation. The JTAG ports play an important role in the development of the chip as well as subsequent maintenance of the chip. A conventional JTAG connection with a chip is illustrated in FIG. 1. As shown in FIG. 1, a computer is coupled to a JTAG port of the chip via test equipment. The JTAG connection can be established mainly using the Test Access Ports (TAP), which includes five ports: Test Clock (TCK), Test Mode Select (TMS), Test Data Input (TDI), Test Data Output (TDO) and Test Reset (TRST). Because one can directly access the logic functions of the chip via the JTAG connection, the JTAG connection can be a potential safety risk to an end user and/or the chip itself if its access is not restricted.

Presently, there are two types of security measures to safeguard JTAG connections using: (1) security fuses or (2) security logic modules. A security fuse technique is to set a fuse on a key path of the JTAG connection. When there is no need for testing, the fuse is burned by applying a fuse burning voltage to certain terminals of the chip. As a result, the test functions of the JTAG ports are prohibited. The advantage of this approach is that it can disable the functions of the JTAG ports physically. However, such an approach is irreversible. Once the security fuse is broken, the testing functions of the JTAG ports cannot be restored if further JTAG testing is desired in the future. The security logic module technique involves adding a security module inside the chip. When the chip is tested, a password is required to change a value in the security module's register to enable/disable the JTAG ports. This technique is simple and effective, but its operation is complicated because the password must be provided each time before and after a testing session.

### BRIEF DESCRIPTION OF THE DRAWINGS

FIG. 1 illustrates a JTAG connection configured in accordance with the prior art.

FIG. 2 illustrates a secure JTAG connection authentication system in accordance with the present disclosure.

FIG. 3 is a flow chart illustrating an authentication method in accordance with an embodiment of the present disclosure.

FIG. 4 is a flow chart illustrating an authentication method in accordance with another embodiment of the present disclosure.

### DETAILED DESCRIPTION

Specific details of several embodiments of the disclosure are described below with reference to processes and apparatus for establishing a secured connection with a JTAG port. Several other embodiments of the invention may have different configurations, components, or procedures than those described in this section. A person of ordinary skill in the art, therefore, will accordingly understand that the invention may have other embodiments with additional elements, or the invention may have other embodiments without several of the elements shown and described below.

### Overview

One aspect of the present disclosure is related to providing authentication processes and apparatus for authenticating access to a JTAG port in a chip. Embodiments of the processes can automatically identify permitted access to the JTAG ports and enable/disable the JTAG functions accordingly to prevent illegal access to the internal logic of the chip.

Another aspect of the present disclosure is related to a JTAG connection authentication system (the “system”). In certain embodiments, the system can be positioned between the test equipment and the chip to be tested. The system includes an access module having an interactive interface and authentication module. In certain embodiments, the authentication module is disposed in the chip and is connected with the TAP ports of the chip. The access module is connected with the TAP ports at the test equipment as well as the TAP ports of the chip. The access module and the authentication module include local private keys K and K′ for authentication.

Another aspect of the present disclosure is an authentication process for establishing a secured connection with JTAG ports. In certain embodiments, the authentication process can include the following operations:

A. One of the access module and the authentication module originates a authentication request, while the other generates a random number RN;

B. The access module calculates an authentication code X′ for RN using the local private key K′, and sends X′ to the authentication module;

C. The authentication module calculates an authentication code X for RN using the local private key K;

D. The authentication module compares X and X′, and decides whether to open the TAP port of the chip;

E. The authentication module returns the authentication result to the access module.

The above-mentioned operation A can further include the following operations:

A1. The access module originates the authentication request to the authentication module;

A2. The authentication module generates the RN and sends the generated RN to the access module after receiving the authentication request;

The above-mentioned operation A can further include the following operations:

A1′. The authentication module originates the authentication request to the access module;

A2′. The access module generates the RN after receiving the authentication request.

In operation B described above, the local private key K′ is used to calculate the authentication code X′ for RN, and the access module sends RN as well as X′ to the authentication module. In operation C described above, the authentication module, after receiving RN and X′, calculates the authentication code X using the local private key K.

Unlike the security fuse technique, the technique disclosed in the present application can be reversible and reusable. Further, compared with the technique using a security logic module, the disclosed technique is simple, and there is no need for passwords to enable/disable the JTAG ports. Furthermore, the disclosed technique reduces the risk of stolen of passwords.

### System and Processes

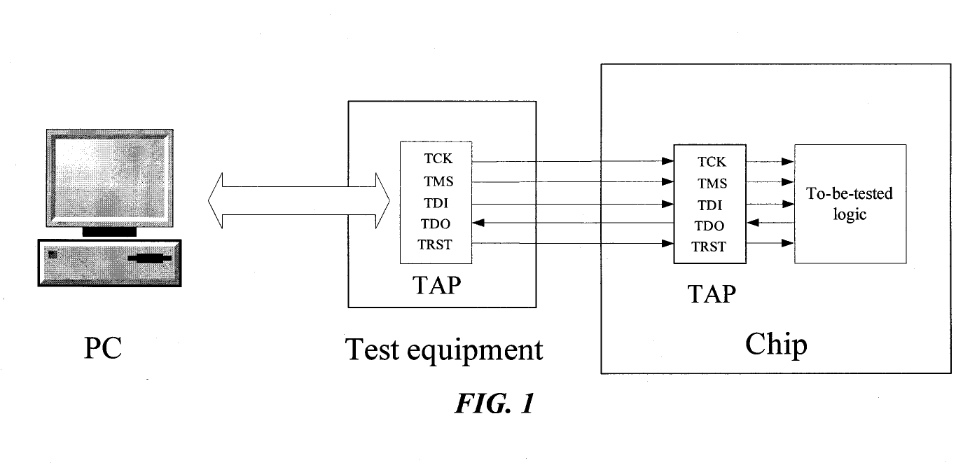

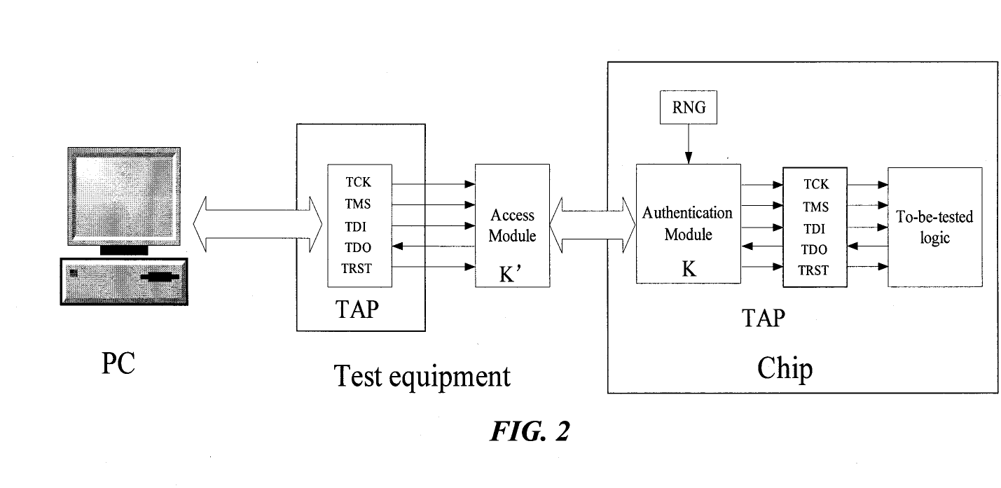

FIG. 2 illustrates a secure JTAG connection authentication system in accordance with the present disclosure. As illustrated in FIG. 2, the system includes two additional modules than the system in FIG. 1: the access module and the authentication module. As depicted by FIG. 2, the access module is disposed outside the chip while the authentication module is disposed inside the chip. Both the access and authentication modules include the same private key. When the test interface accesses the chip, the access module and the authentication module undertake an authentication process. After the authentication, the authentication module enables the JTAG ports on the chip to allow the computer to modulate the chip.

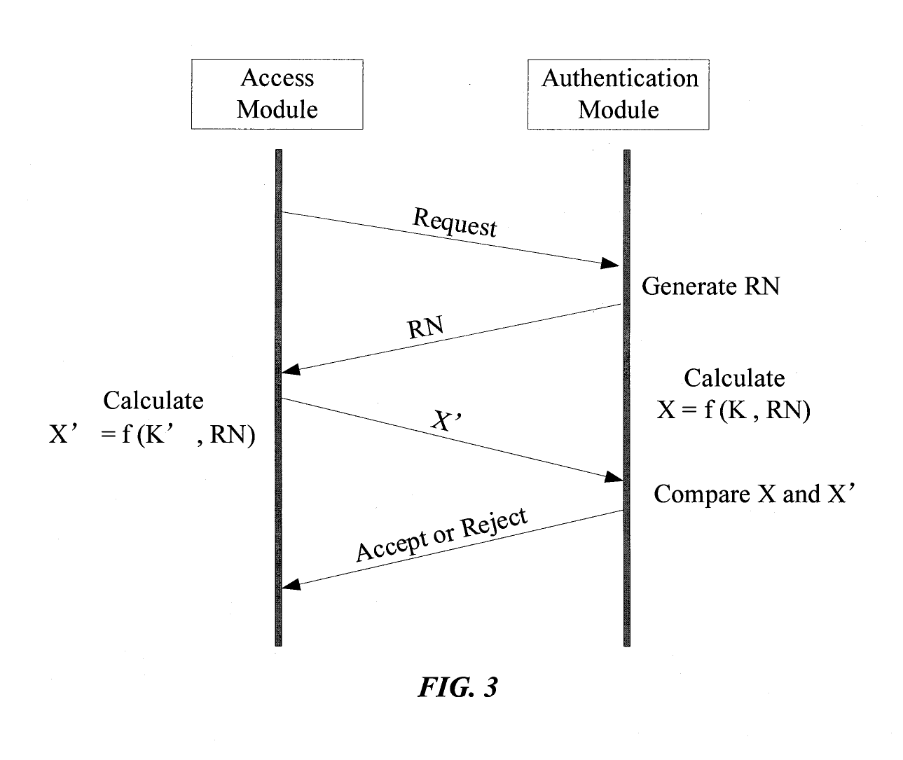

FIG. 3 is a flow chart illustrating an authentication method in accordance with an embodiment of the present disclosure. As illustrated in FIG. 3, the method can include the following operations:

Operation 1: the access module originates an authentication request to the authentication module;

Operation 2: The authentication module, after receiving the authentication request, generates a RN, and sends the generated RN to the access module;

Operation 3, the access module calculates an authentication code X′ based on the RN generated in Operation 2 using the local private key K′, and returns the calculated authentication code X′ to the authentication module while the authentication module calculates another authentication code X based on the RN generated using the local private K;

Operation 4: the authentication module compares the two authentication codes to determine whether they are the same: X=X′ or X≠X′, and decide whether to enable the TAP port on the chip;

Operation 5: the authentication module returns the result to the access module.

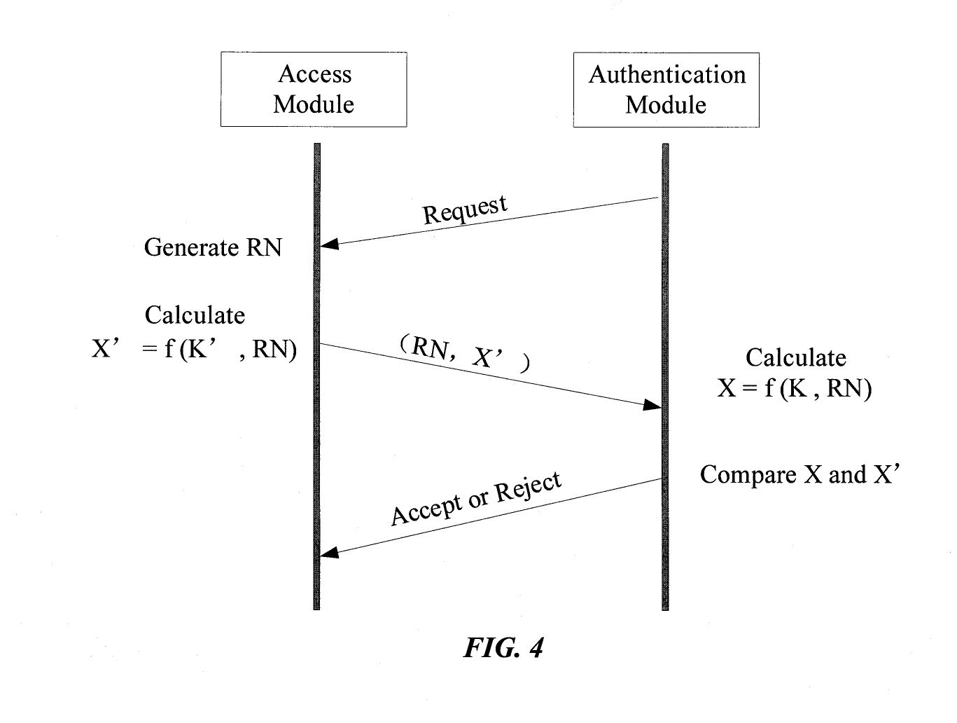

FIG. 4 is a flow chart illustrating an authentication method in accordance with another embodiment of the present disclosure. In this embodiment, the authentication originator has changed. The module that generates the authentication request can be the authentication module in the chip, and the authentication operations can include the following:

Operation 1: the authentication module generates an authentication request to the access module;

Operation 2: the access module generates a random number RN after receiving the authentication request, calculates the authentication code X′, and sends RN and X′ to the authentication module;

Operation 3: the authentication module, after receiving RN and X′, calculates the authentication code X based on RN using the local private key K;

Operation 4: the authentication module compares the two authentication codes to see whether they are the same: X=X′, or X≠X′, and to decide whether to enable the TAP port on the chip.

Operation 5: the authentication module returns the authentication result to the access module.

From the foregoing, it will be appreciated that specific embodiments of the invention have been described herein for purposes of illustration, but that various modifications may be made without deviating from the invention. Many of the elements of one embodiment may be combined with other embodiments in addition to or in lieu of the elements of the other embodiments. Accordingly, the invention is not limited except as by the appended claims.

fch I/We claim:

1. A system for performing JTAG connection authentication, comprising:
an access module coupled to a test interface of a TAP port on a chip; and
an authentication module coupled to the TAP port on the chip, wherein the access module and the authentication module include local private keys K and K′ for the authentication, respectively.

2. The system of claim 1 wherein one of the access module and the authentication module originates an authentication request while the other generates a random number RN, and wherein the access module calculates a first authentication code X′ based on RN using the local private key K′, and sends X′ to the authentication module, and wherein the authentication module calculates a second authentication code X based on RN using the local private key K and compares X to X′, and decides whether to enable the TAP port based on the comparison.

3. The system of claim 2 wherein the access module originates the authentication request to the authentication module and the authentication module, after receiving the authentication request, generates the RN, and sends the generated RN to the access module.

4. The system of claim 2 wherein the authentication module originates the authentication request to the access module and the access module generates the RN after receiving the authentication request.

5. The method for authenticating access to a JTAG port in a chip, comprising:
starting an authentication request by one of an access module and an authentication module while the other generates a random number RN;
calculating a first authentication code X′ based on RN using the local private key K′ at the access module and sending X′ to the authentication module;
calculating a second authentication code X based on RN using the local private key K at the authentication module;
comparing the first authentication code X′ to the second authentication code X;
determining whether to enable the JTAG port based on the comparison; and
returning the authentication result to the access module.

6. The method of claim 5 wherein starting an authentication request further includes:
starting the authentication request at the access module before sending the authentication request to the authentication module; and
after receiving the authentication request, generating the RN and sending the generated RN to the access module at the authentication module.

7. The method of claim 5 wherein starting an authentication request further includes:
starting the authentication request at the authentication module and sending the authentication request to the access module; and
generating the RN after receiving the authentication request at the access module.
